(19) United States
(12) Patent Application Publication
(10) Pub. No.: US 2011/0168056 A1
(43) Pub. Date: Jul. 14, 2011

(54) ALLOY PARTICLE AND WIRE USED IN AIR PLASMA SPRAY OR WIRE ARC SPRAY

(75) Inventors: Seiji Kuroda, Ibaraki (JP); Zhen Su Zeng, Ibaraki (JP); Jin Kawakita, Ibaraki (JP); Hideyuki Murakami, Ibaraki (JP); Masayuki Komatsu, Ibaraki (JP)

(73) Assignee: NATIONAL INSTITUTE FOR MATERIALS SCIENCE, Tsukuba-shi, Ibaraki (JP)

(21) Appl. No.: 13/119,881

(22) PCT Filed: Sep. 24, 2009
(86) PCT No.: PCT/JP2009/066508

§ 371 Date: Mar. 18, 2011

(30) Foreign Application Priority Data
Sep. 22, 2008 (JP) 2008-243206

(51) Int. Cl. C09D 1/00

(52) U.S. Cl. 106/286.3

(57) ABSTRACT

The present invention relates to improvement in alloy powder particles or wires used as a source material in atmospheric plasma spray and wire arc spray to reduce the amount of oxides on the thermal-sprayed coating.

The alloy particles and the wire of the present invention 1 are doped with at least an element to be oxidized and evaporated preferentially as compared to the major alloy elements on the particle surface during flight by spraying.

### TECHNICAL FIELD

The present invention relates to alloy powders and wires used in atmospheric plasma spray or wire arc spray which produces alloy coating composed of the particles deposited on a substrate by spraying the alloy particles generated by heating the alloy powder or wires to a temperature above its melting point onto the substrate.

### BACKGROUND ART

Thermal spraying is a technology of deposition in which source powder particles or a wire is melted and sprayed onto a substrate with a high temperature heat source.

Atmospheric plasma spray (APS) is commonly used because even materials having a high melting point can be sprayed. Although wire arc spray is usually used in thermal spraying of metal materials due to the high efficiency in forming a coating using a source metal wire, the lower particle velocity compared to that of plasma spray is liable to cause a higher porosity. Thermal spraying of metal materials by APS or wire arc spray has a problem that oxides contaminate the deposit due to oxidation of the metal particles by air during spraying.

Consequently, the coating compositions vary to produce chemically inhomogeneous structure. In addition, formation of layers of the oxides together with metal particles makes a porous coating, which is lower in adhesion and corrosion resistance than the source material.

For this reason, various methods of preventing oxidation of thermal-sprayed coatings have been investigated.

Such methods include spraying in an inert gas chamber under exclusion of air for controlling the atmosphere during spraying. The method is called low pressure plasma spray and in practical use. However, due to the inefficiency and high cost of the method in view of industrial production, the method finds limited applications. Alternative methods include low temperature spray, for example cold spray, in which sprayed particles are not melted before deposition. However, the materials that can be readily deposited by the method are limited only to soft metals such as copper and aluminum. Even if the deposition is performed, in many cases the coating has poor compactness and adhesion due to insufficient deformation of the particles.

### DISCLOSURE OF THE INVENTION

### Problems to be Solved by the Invention

The present invention relates to improvement in alloy powder particles and wires used as a source material in atmospheric plasma spray and wire arc spray, respectively, to reduce the amount of oxides on the thermal-sprayed coating.

### Means for Solving the Problems

The alloy powders and the wires of the present invention 1 are doped with at least one element to be oxidized and evaporated on the particle surface during flight by spraying.

### ADVANTAGES OF THE INVENTION

According to the present invention 1, oxidation of the main elements constituting the coating to be produced can be prevented by oxidation and evaporation of the doped elements, and contamination of the coating with oxides can be thus prevented.

### BEST MODE FOR CARRYING OUT THE INVENTION

In the present invention, the source material is doped with at least one alloy element that produces volatile oxides in the atmosphere during thermal spraying at high temperature. A principle was discovered that the elements which preferentially react with oxygen in the atmosphere to form oxides that readily evaporate during spraying effectively reduce the oxygen content in the coating. The present invention was achieved based on the principle.

Specifically, requirements for the doping element (hereinafter referred to as an element to be oxidized and evaporated) include (i) having a higher affinity for oxygen than the major elements constituting the coating and (ii) producing oxides having a low boiling point that can be readily evaporated.

Effectiveness of elements B, Si, and C were confirmed by experiments.

The contents of the elements to be oxidized and evaporated are 0.5≦(B)≦3.0, 1.0≦(Si)≦5.0, and 1.0≦(C)≦2.3 wt %, respectively.

When the content is below the lower limit, the effect of the element to be oxidized and evaporated is insufficient to produce a compacted coating. When the content is higher than the upper limit, carbides or borides tend to be formed, which disadvantageously make a more brittle coating.

Fe, Ni, Co, Mo, or Cu, which is commonly used as coating element in atmospheric plasma spray, can be used as main element of the coating.

Furthermore, a coating of an alloy such as Fe—Cr, Ni—Cr, or Fe—Cr—Ni—Mo, which has been conventionally difficult to produce properly by atmospheric plasma spray due to severe oxidation, can be produced with much less oxidation.

### Embodiments

In the present invention, thermal spraying devices shown in FIGS. 8 and 9 were used in atmospheric plasma spray and wire arc spray, respectively. Since the devices are publicly known, detailed explanation is omitted.

Alloy particles shown in the following Table were thermal-sprayed onto a substrate (carbon steel SS400) with an atmospheric plasma spray device shown in FIG. 8 under conditions shown in the Table. The results are shown in the following Table.

Although a spray distance of 100 mm is appropriate in normal plasma spray conditions, experiments were performed in a high-temperature, low-oxidation spray region (a spray distance of 50 mm) and in a high-oxidation region (a spray distance of 150 mm or 200 mm) for better understanding of the relations between the doping element and oxidation.

Compositions of the alloy particles and element contents in the produced coatings were determined by acid dissolution followed by ICP emission spectroscopy.

Oxygen contents were measured by inert gas fusion infrared absorption method (LECO TC600 type).

TABLE 1

| Experiment No. | | | 1-1 | 1-2 | 1-3 | 1-4 | 2-1 | 2-2 | 2-3 | 2-4 | 3-1 | 3-2 | 3-3 | 3-4 |
|---|---|---|---|---|---|---|---|---|---|---|---|---|---|---|
| Alloy | Particle diameter range | | 32-75 | 32-75 | 32-75 | 32-75 | 32-75 | 32-75 | 32-75 | 32-75 | 32-75 | 32-75 | 32-75 | 32-75 |
| particles | (μm) | | | | | | | | | | | | | |
| | Composi- | Coating | Fe | | | | Fe—1Si | | | | Fe—4Si | | | |
| | tion | element | | | | | | | | | | | | |
| | (wt %) | Evaporating | Fe | | | | Si | | | | Si | | | |
| | | element | | | | | | | | | | | | |
| | Melting point (×10° C.) | | 153 | | | | 151 | | | | 148 | | | |
| Spraying | Injection velocity (m/s) | | 115 | 115 | 110 | 105 | 115 | 115 | 110 | 105 | 115 | 115 | 110 | 105 |
| conditions | Particle heating | | 325 | 288 | 270 | 250 | 325 | 288 | 270 | 250 | 325 | 288 | 270 | 250 |
| | temperature (×10° C.) | | | | | | | | | | | | | |
| | Distance to substrate | | 50 | 100 | 150 | 200 | 50 | 100 | 150 | 200 | 50 | 100 | 150 | 200 |
| | (mm) | | | | | | | | | | | | | |
| Produced | Coating thickness (μm) | | 350- | 350- | 350- | 350- | 450 | 450 | 450 | 450 | 450 | 450 | 450 | 450 |
| coating | Composi- | Elements | Fe, O | Fe, O | Fe, O | Fe, O | Fe, Si, | Fe, Si, | Fe, Si, | Fe, Si, | Fe, Si, | Fe, Si, | Fe, Si, | Fe, Si, |
| (100 mm) | tion | constituting | | | | | O | O | O | O | O | O | O | O |
| | (wt %) | coating | | | | | | | | | | | | |
| | | Elements | Fe | Fe | Fe | Fe | Fe, Si | Fe, Si | Fe, Si | Fe, Si | Fe, Si | Fe, Si | Fe, Si | Fe, Si |
| | | remained | | | | | | | | | | | | |
| | | evaporation | | | | | | | | | | | | |

| | | | | | | | | | | | | |
|---|---|---|---|---|---|---|---|---|---|---|---|---|
| Oxygen content (wt %) | 2.2 | 3 | 3.8 | 4.8 | 2.1 | 2.2 | 2.6 | 3.4 | 1.2 | 1.5 | 1.7 | 2.4 |

| | | | |
|---|---|---|---|
| Cross-sectional view | FIG. 5 | FIG. 6 | FIG. 6 |

| Experiment No. | | | 4-1 | 4-2 | 4-3 | 4-4 | 5-1 | 5-2 | 5-3 | 5-4 |
|---|---|---|---|---|---|---|---|---|---|---|
| Alloy | Particle diameter range | | 32-75 | 32-75 | 32-75 | 32-75 | 32-75 | 32-75 | 32-75 | 32-75 |
| particles | (μm) | | | | | | | | | |
| | Composi- | Coating | Fe—1B | | | | Fe—3B | | | |
| | tion | element | | | | | | | | |
| | (wt %) | Evaporating | B | | | | B | | | |
| | | element | | | | | | | | |
| | Melting point (×10° C.) | | 145 | | | | 128 | | | |
| Spraying | Injection velocity (m/s) | | 115 | 115 | 110 | 105 | 115 | 115 | 110 | 105 |
| conditions | Particle heating | | 325 | 288 | 270 | 250 | 325 | 288 | 270 | 250 |
| | temperature (×10° C.) | | | | | | | | | |
| | Distance to substrate | | 50 | 100 | 150 | 200 | 50 | 100 | 150 | 200 |
| | (mm) | | | | | | | | | |
| Produced | Coating thickness (μm) | | 350 | 350 | 350 | 350 | 350 | 350 | 350 | 350 |
| coating | Composi- | Elements | Fe, B, | Fe, B, | Fe, B, | Fe, B, | Fe, B, | Fe, B, | Fe, B, | Fe B |
| (100 mm) | tion | constituting | O | O | O | O | O | O | O | O |
| | (wt %) | coating | | | | | | | | |
| | | Elements | Fe, B | Fe, B | Fe, B | Fe, B | Fe, B | Fe, B | Fe, B | Fe, B |
| | | remained | | | | | | | | |
| | | evaporation | | | | | | | | |

| | | | | | | | | |
|---|---|---|---|---|---|---|---|---|
| Oxygen content (wt %) | 1.3 | 1.5 | 1.9 | 2.3 | 0.25 | 0.42 | 0.52 | 0.95 |

| | | |
|---|---|---|
| Cross-sectional view | FIG. 7 | FIG. 7 |

Powder particle diameters are expressed by the openings of the screens used in sieving the powder. In the case of 35 to 75 μm, the powder was sieved with sieves having screen openings of 35 μm and 75 μm, respectively.

Discussions based on Experiments No. 1 to No. 3 (See FIG. 1)

Effect of doping with Si: The horizontal axis represents spray distance (usually about 100 mm). Oxygen contents in the alloy coatings in which iron was doped with Si are represented. The oxygen content increased with the increase in spray distance. Fe1Si and Fe4Si that were doped with Si had thermal-sprayed coatings with reduced oxygen content compared to pure iron. The coating with a Si content of 4 wt % was less oxidized compared to the coating with a content of 1 wt %.

Discussions based on Experiments No. 1 to No. 3 (See FIG. 2)

Variations in Si content in the coatings in FIG. 1 with varying spray distance are shown. The Si content in the coatings decreased with increase in spray distance. The Si content more decreased with increase in Si content of the source powder. Considering the results shown in FIG. 1, it is contemplated that the coating was less oxidized with more decreased Si resulting from the increased content of the doped Si.

Discussions based on Experiments No. 1, No. 4 and No. 5 (See FIG. 3)

Effect of doping with B: The horizontal axis represents spray distance (usually about 100 mm).

Oxygen contents in the coatings in which iron was doped with B are represented. The oxygen content in the coatings increased with the increase in spray distance.

The coatings that were doped with B had more reduced oxygen content compared to pure iron. The coating with a B content of 3 wt % was less oxidized compared to the coating with a content of 1 wt %.

Discussions based on Experiments No. 1, No. 4 and No. 5 (See FIG. 4)

B contents in the coatings in FIG. 3 are shown. The B content in the coatings decreased with increase in spray distance.

Although the coatings produced from source powder with a B content of 3 wt % contained slightly more reduced B compared to those from the source powder with a B content of 1 wt %, it is evident that the coatings with the higher B content were significantly less oxidized from the results of oxygen contents shown in FIG. 3.

### BRIEF DESCRIPTION OF THE DRAWINGS

FIG. 1 is a graph showing oxygen contents in the coatings in Experiments No. 1 to No. 3;

FIG. 2 is a graph showing Si contents in the coatings in Experiments No. 1 to No. 3;

FIG. 3 is a graph showing oxygen contents in the coatings in Experiments No. 1, No. 4, and No. 5;

FIG. 4 is a graph showing B contents in the coatings in Experiments No. 1, No. 4, and No. 5;

FIG. 5 is a photograph of a cross section of pure iron coating in Experiment 1 showing the structure containing much grey oxide;

FIG. 6 shows photographs of cross sections of Fe—Si coatings in Experiments 2 and 3 showing the coatings having less content of grey oxides compared to the pure iron coating in FIG. 5. The Fe-4Si coating has fewer regions of grey oxides compared to the Fe-1Si coating, having gas cavities;

FIG. 7 shows photographs of cross sections of Fe—B coatings in Experiments 4 and 5 showing the coatings having less content of grey oxides compared to the pure iron coating in FIG. 5. The Fe-3B coating has less content of grey oxides compared to the Fe-1B coating;

FIG. 8 is a schematic of plasma spray device used in the present invention (Embodiment); and

FIG. 9 is a schematic of wire arc spray device used in the present invention.

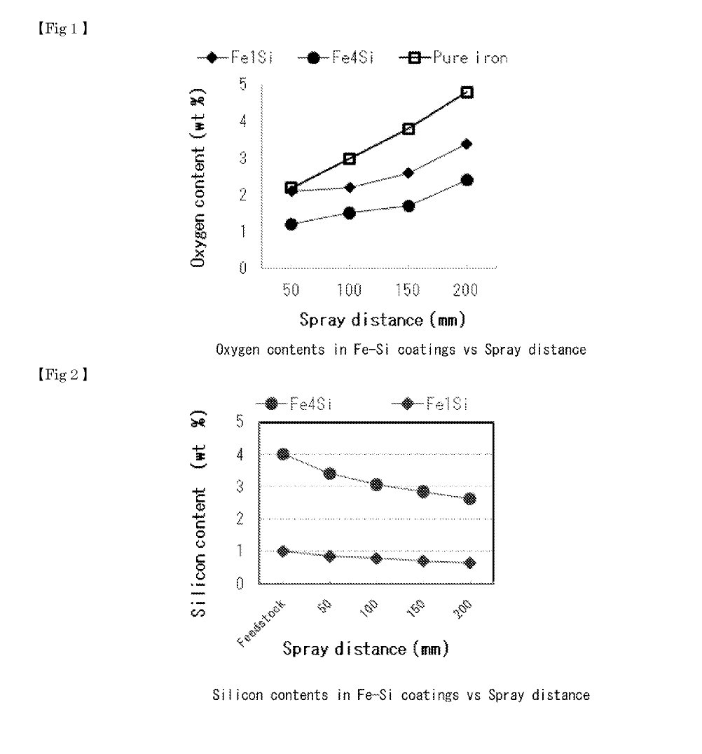

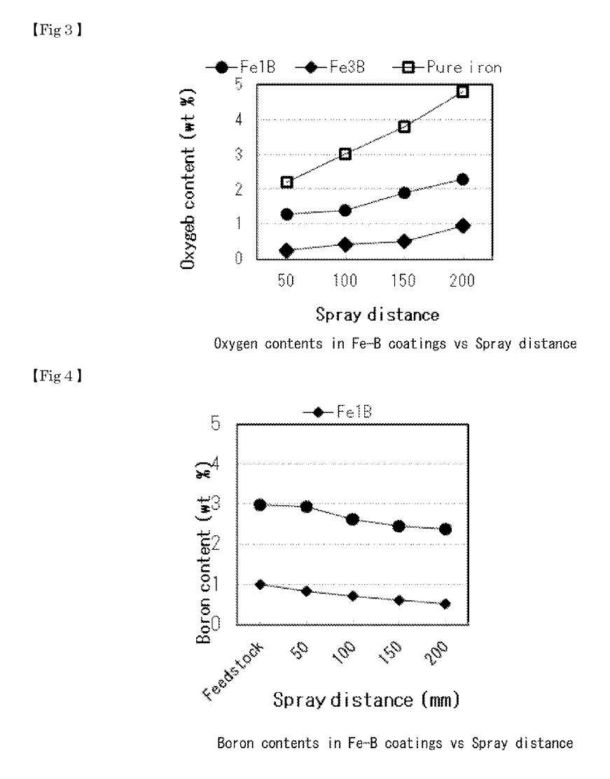

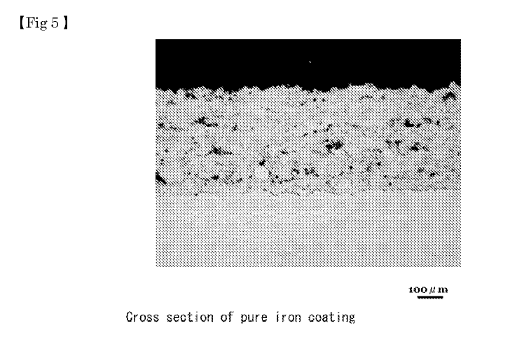

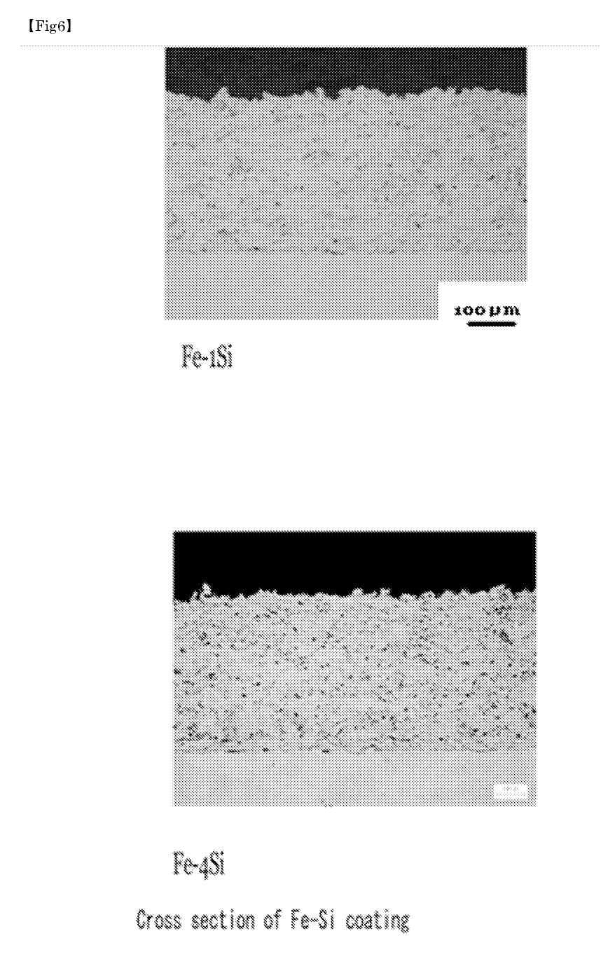

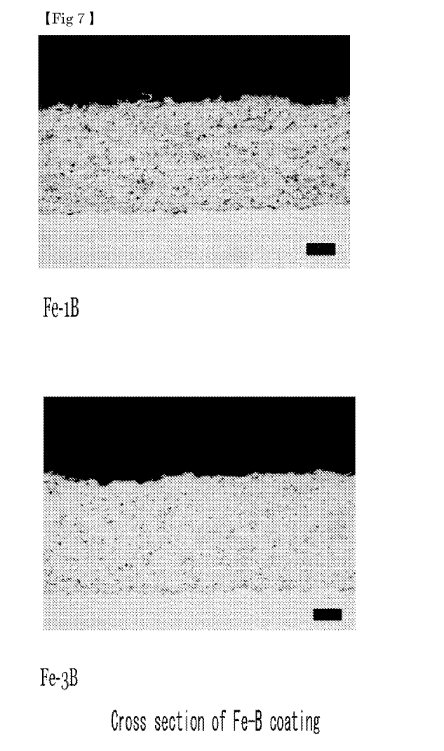

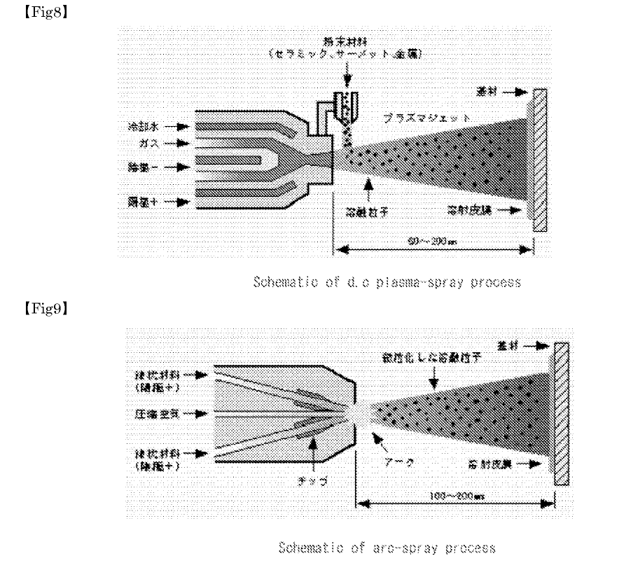

1. Alloy powders or wires used in a process of thermal spraying in the air using a heat source, such as arc discharge or thermal plasma, including atmospheric plasma spray or wire arc spray, wherein the process produces an alloy coating derived from the particles or the wire on a substrate by spraying the alloy particles heated at a temperature above the melting point onto the substrate comprising at least a doping element to be oxidized and evaporated on the particle surface during flight by spraying.
